(19) United States
(12) Patent Application Publication
(10) Pub. No.: US 2020/0060231 A1
(43) Pub. Date: Feb. 27, 2020

(54) Multi-Shift Button-Type Brush

(71) Applicant: ENGREAT PET PRODUCTS (SHENZHEN) CO., LTD., Shenzhen (CN)

(72) Inventor: Jui-Tsang Lin, Shenzhen (CN)

(21) Appl. No.: 16/207,181

(22) Filed: Dec. 2, 2018

(30) Foreign Application Priority Data
Aug. 23, 2018 (CN) 201810969216.7

(51) Int. Cl. A01K 13/00

(52) U.S. Cl. CPC A01K 13/002

(57) ABSTRACT

A multi-shift button-type brush includes a handle and a brush head portion; the brush head portion is provided therein with a combing member having combing teeth, wherein an upper end of the brush head portion is provided with a button, below the corresponding button on the brush head portion is disposed a combing member receiving groove, the combing member is connected to the button via a movable assembly, the combing member is arranged in the receiving groove, and the button is pressed/rebounded to push the combing member to be positioned at different positions relative to the receiving groove; the movable assembly is provided with clamping ends with different limiters correspond to the lengths of the combing member extending out of the receiving groove. The use of the multi-shift button-type brush according to the present application is simple and convenient, and the structure thereof is exquisite.

### CROSS REFERENCE

This application claims priority of Chinese Patent Application No. 201810969216.7, filed on Aug. 23, 2018, entitled “multi-shift button-type brush”, which is hereby incorporated herein by reference as if fully set forth herein.

### TECHNICAL FIELD

The present application relates to a brush for pets, and more particularly to a multi-shift brush using one-touch controlling.

### BACKGROUND

The existing brushes generally cannot adjust the depth of the comb tooth according to the amount of fur that needs to be combed, and result in the need of purchasing different products for using with different pets, and the use is limited. While some products cannot remove the fur enwound on the comb tooth when combing, but need to manually remove the fur, which is troublesome, and some products can remove the fur by using a button to press a fur removing plate button, but such products needs to be equipped with extra accessories, thereby resulting in a complicated structure.

### SUMMARY

The present application provides a multi-shift button-type brush which adopts a button to make a brush member stretch out or retract into the comb head. When the comb head retracts into the comb head, the fur can be removed by the housing of a brush head, and the button brush can realize the switch among different limiters by one button, the use of button brush is simple and convenient, and the structure thereof is exquisite.

The multi-shift button-type brush according to the present application includes a handle and a brush head portion. The brush head portion is provided therein with a combing member having combing teeth, wherein the brush head portion is provided with a button at an upper end thereof, below the brush head portion there is disposed a combing member receiving groove located below a corresponding button, the combing member is configured to connect with the button via a movable assembly and to arrange into the receiving groove, and the combing member is shifted to different positions relative to the receiving groove by pressing/rebounding the button to push the combing member; the movable assembly is provided with a holding end with different limiters correspond to the lengths of the combing member extending out of the receiving groove.

The movable assembly includes a shifter, a pushing member, a control member and an elastic member; the shifter is connected under the button, and the elastic member is arranged between the button and the shifter, and limiters of different heights are provided on the shifter, the button is configured to pass through the shifter and be fastened to the pushing member, and a lower edge of the pushing member is provided with a saw teeth-shaped convex-concave structure, and a periphery of a lower portion of the control member is provided with docking stations corresponding to the saw teeth, the docking station is configured to hold both a lower edge of the pushing member and the limiters of different heights of the shifter, the control member is connected with the combing member to push the combing member to move.

The docking station of the control member is a convex strip, an end of the convex strip towards the pushing member is sharp corner shaped, and the sharp corner end is a sharp corner structure having a vertical line on one side and an oblique line on another side.

The saw teeth convex-concave structure of the pushing member, a sharp corner of a convex portion and the docking station of the control member are having a same sharp corner structure having a vertical line on one side and an oblique line on another side.

The control member is inserted into a hollow hole of the pushing member, and the docking station of the control member abuts against a lower edge of the pushing member, and the combination of the control member and the pushing member is installed into the shifter, and the shifter is provided with limiters on the inner wall thereof, and the docking stations of the control member is simultaneously held to the limiters.

The button-type brush is a three-position control type, and the shifter is provided with three limiters of different heights.

The control member includes at least one docking station, and when the number of the docking station is more than one, then all the docking stations are evenly distributed along a circumference.

The control member includes three convex ribs, which are evenly distributed along the circumference, and an inner wall of the shifter is provided with three consecutively connected limiter units, each limiter units corresponding to a convex rib occupied ⅓ of the circumference of the circle, each limiter units is provided with limiters of three different heights, and the pushing member is correspondingly provided with nine saw teeth protrusions evenly distributed along the circumference, each set of the protrusions is occupied 40° of the circumference.

The combing member includes a combing blade and a fixing seat, the combing blade is fastened and fixed on the fixing seat, and the fixing seat is connected with the control member, the fixing seat is provided with a positioning post, and a body of the combing blade is provided with positioning hole, the combing blade is pushed to the fixing seat during installation, and the positioning post is held into the positioning hole for fixing the combing blade.

A return spring is disposed between the combing member and the brush head.

The multi-shift button-type brush according to the present application controls the combing member to be switched in different limiters by one button, in order to realize difference of telescopic state and depth of extension of the combing member, in order to realize process of combing and automatically fur removing objects with different fur depths. The process is easy to use and easy to operate, and the structure is exquisite.

### BRIEF DESCRIPTION OF THE DRAWINGS

FIG. 1 is an overall structure schematic view showing of a multi-shift button-type brush according to the present application;

FIG. 2 is an overall split structure schematic view of the multi-shift button-type brush according to the present application;

FIG. 3 is a schematic structural view of a combing member of a multi-shift button-type brush according to the present application;

FIG. 4 is a schematic view showing the internal structure of a shifter of a multi-shift button-type brush according to the present application;

In the drawings, the reference numerals are listed and referred to as follows:
10. brush head portion; 11. button; 12. elastic member; 13. shifter; 131. limiter; 14. pushing member; 141. saw teeth; 15. control member; 151. docking station; 16. combing member; 161. combing blade 161; 162. fixing seat; 163. positioning post; 164. positioning hole; 17. spring member; 20. handle; and 30. receiving groove.

### DETAILED DESCRIPTION OF THE EMBODIMENTS

The multi-shift button-type brush of the present application will be further described in detail below in combination with the drawings and specific embodiments of the present application.

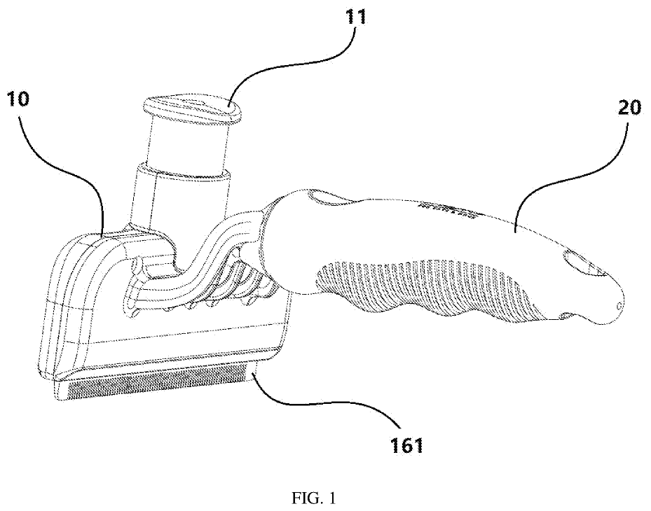

Embodiment 1: please refer to FIG. 1, the embodiment is showing of detailed description of a three-position button-type brush, in which a multi-shift button-type brush is shown to include a handle 20 and a brush head portion 10, the brush head portion 10 includes a portion of an outer housing and an inner component, a button 11 is mounted to the inner of the outer housing and connected with the inner component, and the brush head portion is provided therein with a combing member having combing teeth, and the combing member is extendable from the inner of the outer housing.

A button 11 is disposed at an upper end of the brush head portion 10, and below the corresponding button 11 on the brush head portion 10 is disposed a receiving groove 30 for receiving the combing member, the combing member 16 is connected to the button 11 by a movable assembly, the combing member 16 is arranged in the receiving groove 30, and the button 11 is pressed/rebounded to push the combing member 16 to be positioned at different positions relative to the receiving groove 30; the movable assembly is provided with a holding end with different limiters, which are corresponding to the lengths of the combing member 16 extending out of the receiving groove 30.

The movable assembly includes a shifter 13, a pushing member 14, a control member 15 and an elastic member 12; the shifter 13 is connected under the button 11, and the elastic member 12 is arranged between the button 11 and the shifter 13, it can be seen in the figures that the elastic member 12 is a spring, the spring is held between the shifter 13 and the button 11, and the spring is responsible for implementing the return of the button 11.

The shifter 13 is provided with limiters of different heights, the function of the shifter 13 is to hold the control member in position and limit the upper and lower positions of the control member. The button 11 is configured to pass through the shifter 13 and be fastened to the pushing member 14, and a lower edge of the pushing member is provided with saw teeth 14, the saw teeth 14 are convex-concave structures, and a periphery of a lower portion of the control member 15 is provided with docking stations 151 corresponding to the saw teeth 14, the docking stations 151 are correspondingly to held both saw teeth 141 at a lower edge of the pushing member and the limiters of different heights of the shifter 13, the control member 15 is connected with the combing member 16 to push the combing member 16 to move.

The docking station 151 of the control member is a convex strip, an end of the convex strip facing the pushing member is sharp corner shaped, and the sharp corner end is a sharp corner structure having a vertical line on one side and an oblique line on another side.

The saw teeth 141 convex-concave structure of the pushing member 14, a sharp corner of a convex portion and the docking station of the control member 15 are having a same sharp corner structure having a vertical line on one side and an oblique line on another side.

The control member 15 is inserted into a hollow hole of the pushing member 14, and docking station of the control member 15 abuts against a lower edge of the pushing member 14, and the combination of the control member 15 and the pushing member 14 is installed into the shifter 13, and the shifter 13 is provided with the limiters on the inner wall thereof, and the docking station 151 of the control member 15 is simultaneously held to the limiter 13.

The saw teeth 141 of the pushing member 14 and the docking station 151 of the control member 15 need to cooperate to complete the carry function, and the control member 15 is a member for directly pushing the combing member 16, so that the control member 15 is a member which can move in the space in the telescopic direction of the button the combing member, the control member 15 is pushed by the pushing member 14 via the docking station 151 held against the saw teeth 141 of the pushing member 14, and is moved along an oblique face of the saw teeth 141, it can be seen as a whole, the control member 15 rotates an angle corresponding to a saw tooth 141 via the axis itself. After the rotation, the docking station 151 is correspondingly held to another step limiter 131 of the shifter 13, and finally the docking station 151 is held to be positioned, thereby realizing the switching of the telescopic position.

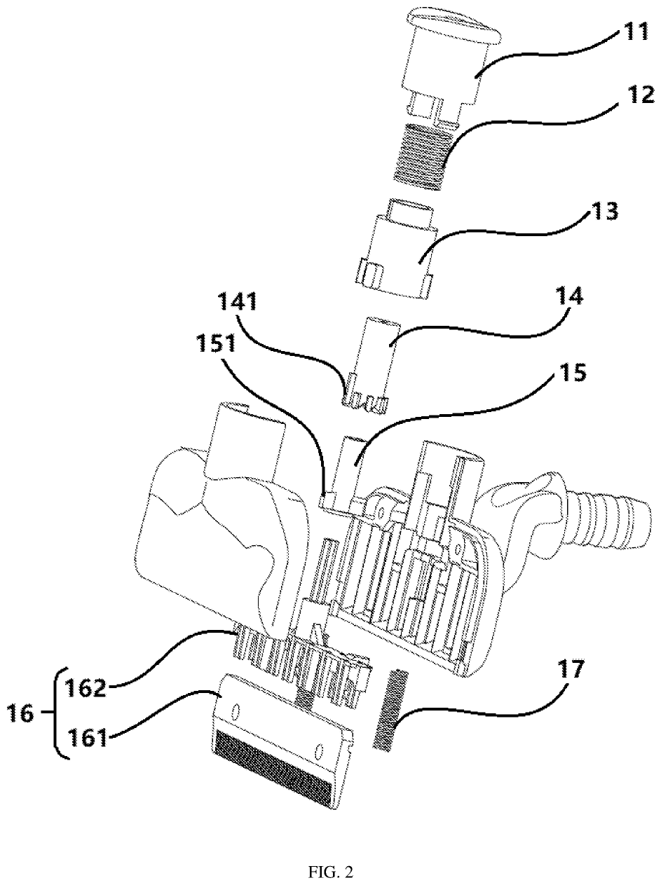

It can be seen from FIG. 2 that the button-type brush is a three-position control type, and the shifter 13 is provided with three limiters of different heights.

Corresponding to the mode of the three-position control, the design of the saw teeth 141 of the pushing member 14 needs to be considered that the angle of rotation of the limiter 131 each time can span a circumference range of a limiter 131.

The control member 15 includes at least one docking station 151, and when the number of the docking station 151 of the control member 15 is only one, the pushing member pushes the control member to rotate via pushing the docking station, it may be a problem of uneven force, so the control member 15 includes at least two or three docking station 151 to share the force.

In the present embodiment, three docking stations are provided, three docking stations are evenly distributed along the circumference, and each of the docking stations is disposed at 0° (360°), 120°, and 240° positions of the circumference respectively.

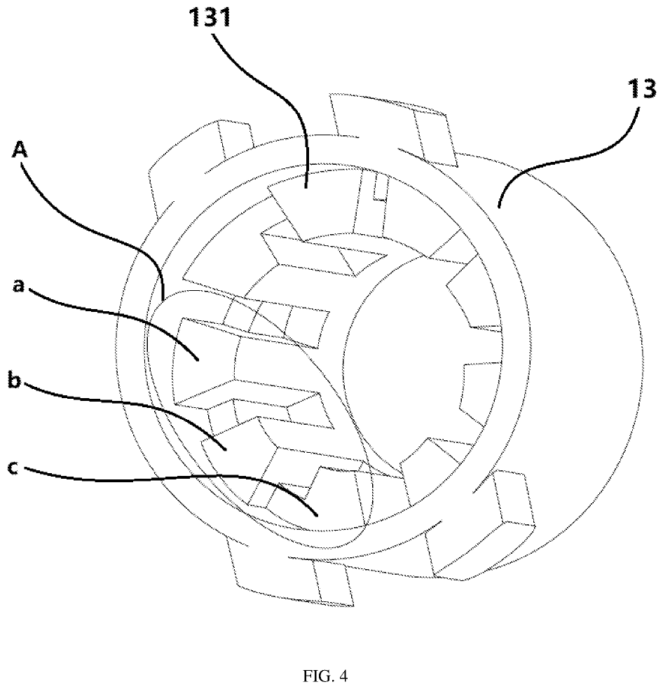

Please refer to FIG. 4, the shifter 13 in the embodiment is shown, and the inner wall of the shifter 13 has three consecutively connected limiter units A, each limiter unit corresponds to a docking station occupied ⅓ of the circumference of the circle, each limiter unit A is provided with limiters of three different heights, which are the first limiter a, the second limiter b and the third limiter c in the figure, which are belong to the limiter 131. Correspondingly, the saw teeth 141 of the pushing member 14 is configured to push the control member 15 to rotate three times in a circle of ⅓, it can be understood that the pushing member is correspondingly provided with nine saw teeth protrusions evenly distributed along the circumference, each of the protrusions is occupied 40° of the circumference.

According to the design of the three docking stations of the control member, the limiter of three different heights is corresponding to each circular span of 120°, three limiter units can be includes in the circumferential range, and each limiter units includes limiters of three different heights.

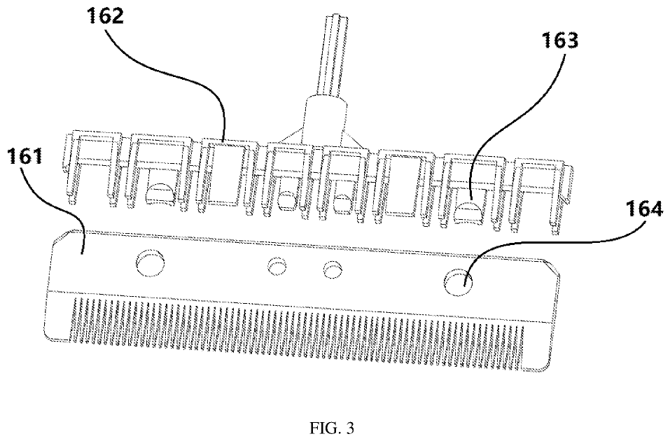

Please refer to FIG. 3, the combing member 16 includes a combing blade 161 and a fixing seat 162, the combing blade 161 is fastened and fixed to the fixing seat 162, and the fixing base 162 is connected with the control member 15, the fixing seat 162 is provided with a positioning post 163, and a body of the combing blade 161 is provided with positioning hole 164, the combing blade 161 is pushed to the fixing seat 162 during installation, the combing blade 161 will be pushed along a guide notch, the positioning hole is corresponding to the positioning post 163 of the fixing seat, when the combing blade 161 is pushed to the predetermined position, and the positioning post 163 is held into the positioning hole 164 for fixing the combing blade 161.

Moreover, in order to push the telescopic restoring action of the combing member, a spring member 17 is also provided between the combing member 16 and an inner of the brush head, which is responsible for completing the return of the combing member.

The above is only a preferred embodiment of the present application, and is not intended to limit the scope of the present application. Although the present application is disclosed by the preferred embodiments thereof, it is not intended to limit the present application, and any skilled person in the art may be modified or modified to be equivalent to equivalent embodiments without departing from the technical scope of the present application, any simple modifications, equivalent changes and modifications made to the above embodiments are within the scope of the technical solutions of the present application.

What is claimed is:

1. A multi-shift button-type brush, comprising: a handle and a brush head portion;
wherein the brush head portion is provided therein with a combing member having combing teeth, wherein the brush head portion is provided with a button at an upper end thereof, below the brush head portion there is disposed a combing member receiving groove located below a corresponding button, the combing member is configured to connect with the button via a movable assembly and to arrange into the receiving groove, and the combing member is shifted to different positions relative to the receiving groove by pressing/rebounding the button to push the combing member; the movable assembly is provided with a holding end with different limiters correspond to the lengths of the combing member extending out of the receiving groove.

2. The multi-shift button-type brush of claim 1, wherein the movable assembly comprises a shifter, a pushing member, a control member and an elastic member; the shifter is connected under the button, and the elastic member is arranged between the button and the shifter, and limiters of different heights are provided on the shifter, the button is configured to pass through the shifter and be fastened to the pushing member, and a lower edge of the pushing member is provided with a saw teeth-shaped convex-concave structure, and a periphery of a lower portion of the control member is provided with docking stations corresponding to the saw teeth, the docking station is configured to hold both a lower edge of the pushing member and one of the limiters of different height of the shifter, the control member is connected with the combing member to push the combing member to move.

3. The multi-shift button-type brush of claim 1, wherein the docking station of the control member is a convex strip, an end of the convex strip towards the pushing member is sharp corner shaped, and the sharp corner end is a sharp corner structure having a vertical line on one side and an oblique line on another side.

4. The multi-shift button-type brush of claim 1, wherein the saw teeth convex-concave structure of the pushing member, a sharp corner of a convex portion and the docking station of the control member are having a same sharp corner structure having a vertical line on one side and an oblique line on another side.

5. The multi-shift button-type brush of claim 1, wherein the control member is inserted into a hollow hole of the pushing member, and the docking station of the control member abuts against a lower edge of the pushing member, and the combination of the control member and the pushing member is installed into the shifter, and the shifter is provided with limiters on the inner wall thereof, and the docking stations of the control member is simultaneously held to the limiters.

6. The multi-shift button-type brush of claim 1, wherein the button-type brush is a three-position control type, and the shifter is provided with three limiters of different heights.

7. The multi-shift button-type brush of claim 1, wherein the control member comprises at least one docking station, and when the number of the docking station is more than one, then all the docking stations are evenly distributed along a circumference.

8. The multi-shift button-type brush of claim 1, wherein the control member comprises three convex ribs, which are evenly distributed along the circumference, and an inner wall of the shifter is provided with three consecutively connected limiter units, each limiter units corresponding to a convex rib occupied ⅓ of the circumference of the circle, each limiter units is provided with limiters of three different heights, and the pushing member is correspondingly provided with nine saw teeth protrusions evenly distributed along the circumference, with each set of the protrusions is occupied 40° of the circumference.

9. The multi-shift button-type brush of claim 1, wherein the combing member comprises a combing blade and a fixing seat, the combing blade is fastened and fixed to the fixing seat, and the fixing seat is connected with the control member, the fixing seat is provided with a positioning post, and a body of the combing blade is provided with positioning hole, the combing blade is pushed within the fixing seat during installation, and the positioning post is held in the positioning hole for fixing the combing blade.

10. The multi-shift button-type brush of claim 1, wherein a return spring is disposed between the combing member and the brush head portion.
